(19) United States
(12) Patent Application Publication
(10) Pub. No.: US 2004/0194716 A1
(43) Pub. Date: Oct. 7, 2004

(54) Pet bowl

(76) Inventor: Mark D. Morrison, New York, NY (US)

Correspondence Address: Hayes Soloway PC, 175 Canal Street, Manchester, NH, 03101, US

(21) Appl. No.: 10/831,396

(22) Filed: Apr. 23, 2004

Related U.S. Application Data
(63) Continuation-in-part of application No. 10/271,642, filed on Oct. 15, 2002.
Application No. 10/271,642 is a continuation-in-part of application No. 10/171,521, filed on Jun. 12, 2002, now abandoned.

(30) Foreign Application Priority Data
Dec. 6, 2003 (US) US 03/18536

(51) Int. Cl. A01K 5/01

(52) U.S. Cl. 119/61.1

(57) ABSTRACT

The apparatus includes a pet bowl having an interior volume defined by a bottom and an upwardly extending sidewall. The pet bowl also has a generally horizontal top surface, integral with the sidewall, with at least one receiving opening formed therein. The apparatus also includes a lip portion partially extending into the interior volume with an access opening formed therethrough. The lip portion has at least one downwardly extending portion that removeably interlocks with the receiving opening of the pet bowl.

### CROSS REFERENCE TO RELATED APPLICATION

This is a continuation in part of copending U.S. patent application Ser. No. 10/271,642 filed Oct. 15, 2002, which is a continuation in part of U.S. patent application Ser. No. 10/171,521, filed Jun. 12, 2002, the entire disclosures of which are incorporated herein by reference.

### FIELD OF THE INVENTION

The present invention relates to animal husbandry and more particularly to a pet bowl with an inwardly directed lip portion to reduce spillage of food and water.

### BACKGROUND OF THE INVENTION

Pet bowls are known in the art. The bowls may be used to hold food or water. The bowls may be made from metal, plastic, or ceramic and may have a base dimension greater than a rim dimension. The bowls may be circular or rectangular. The shape of the inside portion of the bowl is concave and the inside dimension of the bowl typically increases from the base upward. The wall thickness of the bowls is typically uniform.

A drawback to these bowls is that the sloped inside surface of the bowl allows food or water in the bowl to easily spill out when the bowl is moved. Sometimes a pet bowl is moved around by someone walking by, not paying attention, or by the pet attempting to get at food or water. Also, police K-9 units often travel with food and water dishes in their vehicles and the movement of the vehicle can cause the contents to spill. As a result, pet bowls have been developed that have an inwardly directed lip portion to impede water and food from spilling from the bowl. However, these bowls with inwardly directed lips have limitations. Some of the bowls are one-piece units, which impede cleaning the bowls thoroughly. Others have an inwardly directed lip that is removable from the bowl, but the lip never securely attaches, which results in the lip being removed from the bowl with the same jostling that normally spill the contents within the bowl.

Thus, a heretofore unaddressed need exists in the industry to address the aforementioned deficiencies and inadequacies.

### SUMMARY OF THE INVENTION

Embodiments of the present invention provide an apparatus and method for an attachable pet bowl lip.

Briefly described, in architecture, one embodiment of the system, among others, can be implemented as follows. The apparatus includes a pet bowl having an interior volume defined by a bottom and an upwardly extending sidewall. The pet bowl also has a generally horizontal top surface, integral with the sidewall, with at least one receiving opening formed therein. The apparatus also includes a lip portion partially extending into the interior volume with an access opening formed therethrough. The lip portion has at least one downwardly extending portion that removeably interlocks with the receiving opening.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a side view of a first exemplary embodiment of the present invention.

FIG. 2 is a perspective view of the first exemplary embodiment of the present invention, as shown in FIG. 1, showing the full pet bowl and a cut away portion of the lip portion.

FIG. 3 is a top view of a second exemplary embodiment of the pet bowl consistent with the present invention.

FIG. 4 is a side view of the second exemplary embodiment of the lip portion interlockable with the pet bowl shown in FIG. 3.

### DETAILED DESCRIPTION OF THE INVENTION

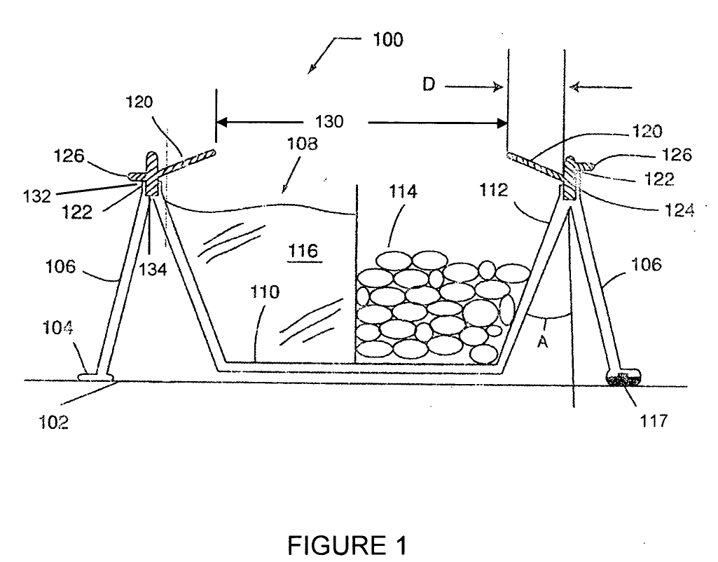

FIG. 1 shows a pet bowl 100 resting on a supporting surface 102. The bowl 100 has a bottom 110 and an upwardly extending sidewall 112 that ends in a top surface 132 to form an interior volume 108. The bowl may be made from a polymeric, metallic, or ceramic material. The general shape of the bowl when viewed from the top may be circular, rectangular, oval, or any other shape. The interior volume 108 may alternately hold water 116 or food 114. The sidewall 112 may have a straight section that is oriented at an angle “A” to the vertical axis. Alternatively, the sidewall may have an arcuate shape. The sidewall 112 may be coupled to a downwardly extending leg portion 106 at the top surface 132. The leg portion 106 may have a foot portion 104 that extends outward. A non-slip pad 117 may be coupled to the foot to increase the sliding resistance of the bowl 100. The feet 104 may elevate the bowl so the bottom surface of the bottom 110 is not in contact with the supporting surface 102. The downwardly extending legs 106 may increase the outside dimension of the bowl 100 to make the bowl more stable.

A lip 120 may be coupled to the sidewall 112 and extends inwardly a distance “D”. The distance “D” is measured from the inside surface of the sidewall at the upper end. The distance “D” is preferably ⅛″ to 1″, more preferably ⅜″ to ¾ and most preferably ½″. An access opening 130 should remain within the lip 120 to allow a pet access to the food 114 or water 116. The lip 120 may be useful for preventing water or food from spilling out from the interior volume 108 when the bowl is moved. The lip 120 may extend around the entire perimeter of the bowl 100. The lip 120 may be removeably interlocked in a recess 122 formed at the top surface 132 using a downwardly extending portion 134 of the lip 120. The downwardly extending portion 134 may be interlocked with the recess 122 using a mechanical or elastomeric fit. An upwardly standing rib 124 may be coupled to the top surface 132 to add structural support. The lip 120 may be made from a polymeric material, including but not limited to, neoprene, olefin, olefin rubber, PVC, isoprene, butyl rubber, butadiene rubber, and urethane. In profile, the inside surface of the lip 120 may be linear or arcuate. The lip 120 may also have an outwardly extending portion 126 which may be helpful in grasping and lifting the bowl 100 or inserting the lip 120.

Alternatively, the lip 120 may be integrally formed with the sidewall 112 and/or the leg portion 106 using a collapsible or fuseable core.

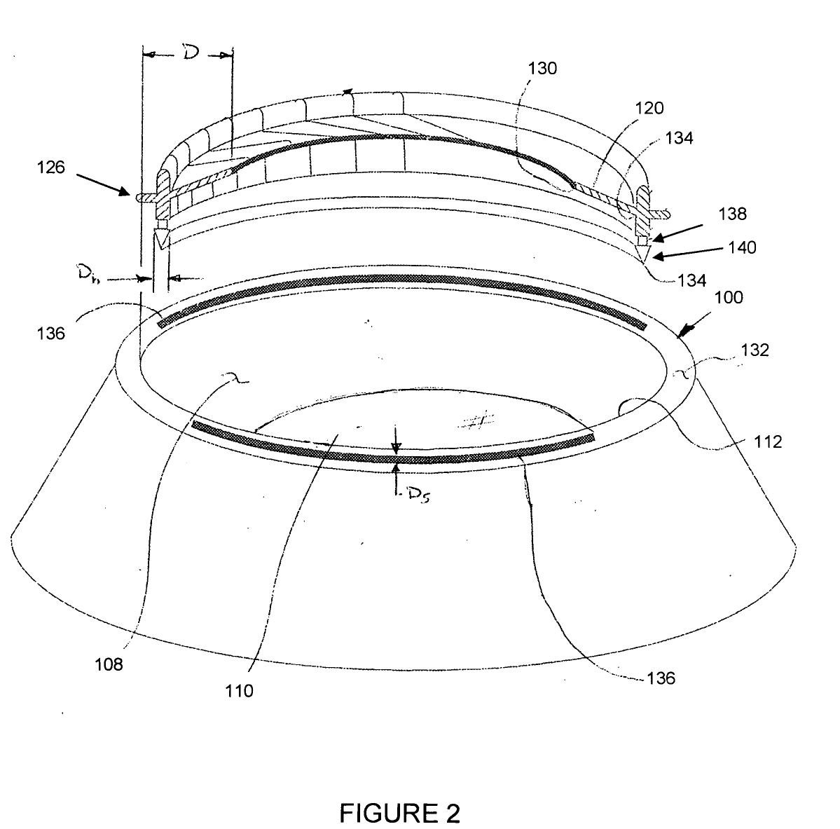

FIG. 2 is a perspective view of the first embodiment of the bowl 100 and lip 120, showing only a cut away portion of the lip 120. The bowl 100 has a bottom 110 and an upwardly extending sidewall 112 that ends in a top surface 132 to form an interior volume 108. The top surface 132 has at least one receiving opening 136 along the perimeter. The receiving opening 136 preferably extends through the top surface 132 and has a width “D_{S}”. The receiving openings 136 are shown as elongated slots, but other shapes including circles are contemplated.

The lip 120 is an inwardly extending portion and may include an outwardly extending portion 126 and a downwardly extending portion 134. An inside edge of the inwardly extending lip 120 may be elevated relative to the top surface 132. Alternatively, the inside edge may be level with or below the top surface 132. When coupled to the bowl 100, the lip 120 extends inward a distance “D”. The distance “D” is measured from the inside surface of the sidewall at the upper end. The distance “D” is preferably ⅛″ to 1″, more preferably ⅜″ to ¾ and most preferably ½″. The lip 120 may be useful for preventing water or food from spilling when the bowl is moved. The inwardly extending lip 120 may extend continuously around the entire perimeter of the bowl 100 and the downwardly extending portion 134 may extend discontinuously around the perimeter of the bowl 100. In a preferred embodiment, the lip 120 includes the inwardly extending portion and the downwardly extending portion 134.

The downwardly extending portion 134 preferably has a profile that is narrower at a tip than at a base. The preferred profile is generally shaped like a solid arrowhead. The profile of the downwardly extending portion 134 shows a neck 138 connected to the lip 120 and a head 140 connected to the neck 138; the head 140 being wider, at its widest dimension, than the neck 138.

The head is preferably sized slightly wider than the dimension “D_{S}” of receiving opening 136. The profile and size of the downwardly extending portion 134 and the dimension of the receiving opening 136 may depend on the types of materials used. In an alternative design, the downwardly extending portions 134 include a plurality of individually spaced protrusions that may be inserted through individual receiving openings 136 in the top surface 132 of the bowl 100.

In an alternative application, the bowl may be used as a litter box to hold pet litter, preferably cat litter.

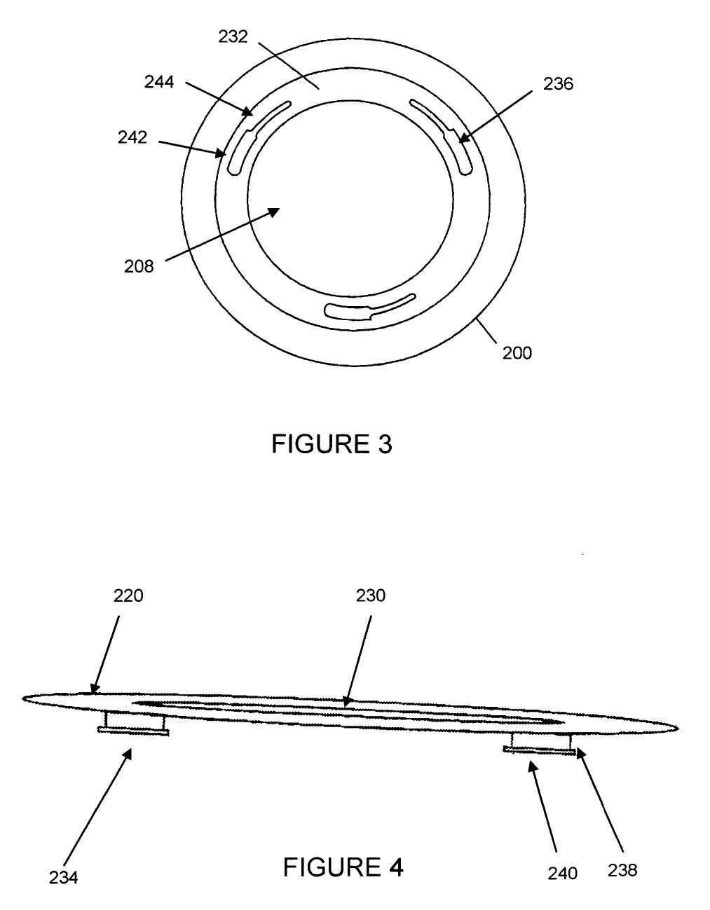

A second embodiment of the present invention is shown in FIG. 3 and FIG. 4 showing a top view of the pet bowl 200 and a side view of the lip 220, respectively. The pet bowl 200 has an interior volume 208 defined by a bottom and an upwardly extending sidewall, much like the first embodiment. The pet bowl also has a generally horizontal top surface 232 with at least one receiving opening 236 formed therein. The lip 220 extends partially into the interior volume 208 with an access opening 230 therethrough. The lip 220 has at least one downwardly extending portion 234 that removeably interlocks with the receiving opening 236. An outwardly extending portion 226 extending along an outer perimeter of the lip 220 provides a grip for attaching the lip 220 to the pet bowl 200 or removing the lip 220 from the pet bowl 200.

The access opening 230 is preferably at least two inches in diameter to provide a pet with access to the interior volume 208. The receiving opening 236 may constitute a hole formed in the top surface 232 or it may be a recess; the receiving opening 236 need only be formed for receiving and interlocking with the downwardly extending portion 234. The downwardly extending portion 234 and the receiving opening 236 may be formed of an elastic polymeric material and interlock to form an elastomeric seal or the downwardly extending portion 234 and the receiving opening 236 may mechanically interlock.

One possible design of the downwardly extending portions 234 and the receiving openings 236 is shown in FIG. 3 and FIG. 4. In FIG. 3, the pet bowl 200 has multiple receiving openings 236 formed in the top surface 232. Each of the receiving openings 236 include a wide receiving opening 242 and a narrow receiving opening 244 formed integral with the wide receiving opening 242. The downwardly extending portions 234 include a neck 238 connected to the lip 220 and a head 240 connected to the neck 238, wherein the head 240 is wider than the neck 238. When connecting the lip 220 to the pet bowl 200, the heads 240 are inserted through the wide receiving openings 242 until the necks 238 are within the wide openings 242. The lip 220 is then rotated in relation to the pet bowl 200, causing the necks to slide from within the wide receiving openings 242 to the narrow receiving openings 244 to interlock the downwardly extending portions 234 to the receiving openings 236.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

I claim:

1. An apparatus, comprising:
a pet bowl having an interior volume defined by a bottom and an upwardly extending sidewall, the pet bowl having a generally horizontal top surface with at least one receiving opening formed therein; and
a lip portion partially extending into the interior volume with an access opening therethrough, the lip portion having at least one downwardly extending portion that removeably interlocks with the receiving opening.

2. The apparatus of claim 1, wherein the lip portion further comprising an outwardly extending portion extending along an outer perimeter of the lip portion thereby providing a grip for attaching the lip portion to the pet bowl or removing the lip portion from the pet bowl.

3. The apparatus of claim 1, wherein the lip portion extends at least ½″ inward of an interior surface of the sidewall.

4. The apparatus of claim 1, wherein the pet bowl and the lip portion are comprised of different materials.

5. The apparatus of claim 1, wherein the downwardly extending portion has a portion width greater than an opening width of the opening.

6. The apparatus of claim 1, wherein the pet bowl consists of one of a polymeric and a metallic material.

7. The apparatus of claim 1, wherein the lip portion consists of one of a neoprene and a butyl rubber.

8. The apparatus of claim 1, wherein the downwardly extending portion has a solid arrow-head profile.

9. The apparatus of claim 1 wherein the access opening is at least two inches in diameter.

10. The apparatus of claim 1, wherein the lip portion comprises one of a neoprene and a butyl rubber.

11. The apparatus of claim 1, further comprising a downwardly extending leg portion coupled to the upwardly extending sidewall by the top surface.

12. The apparatus of claim 1, wherein the receiving opening comprises a recess for securing the downwardly extending portion.

13. The apparatus of claim 1 wherein the downwardly extending portion and the receiving opening are formed of an elastic polymeric material and interlock to form an elastomeric seal.

14. The apparatus of claim 1 further comprising a plurality of receiving openings and a plurality of downwardly extending portions.

15. The apparatus of claim 14 wherein the downwardly extending portions further comprise:
a neck connected to a remainder of the lip portion; and
a head connected to the neck, wherein the head is wider than the neck; and wherein the receiving openings further comprise:
a wide receiving opening; and
a narrow receiving opening formed integral with the wide receiving opening, whereby the head is inserted through the wide receiving opening and the neck slides from the wide receiving opening to the narrow receiving opening to interlock the downwardly extending portions to the receiving openings.

16. An apparatus, comprising:
a pet bowl having an interior volume defined by a bottom and an upwardly extending sidewall, the pet bowl having a generally horizontal top surface with at least one receiving opening formed therein;
a lip portion partially extending into the interior volume with an access opening therethrough, the lip portion having at least one downwardly extending portion that removeably interlocks with the receiving opening; and
an outwardly extending portion extending along an outer perimeter of the lip portion thereby providing a grip for attaching the lip portion to the pet bowl or removing the lip portion from the pet bowl.

17. The apparatus of claim 16 wherein the access opening is at least two inches in diameter.

18. The apparatus of claim 16, wherein the receiving opening comprises a recess for securing the downwardly extending portion.

19. The apparatus of claim 16 wherein the downwardly extending portion and the receiving opening are formed of an elastic polymeric material and interlock to form an elastomeric seal.

20. An apparatus, comprising:
a pet bowl having an interior volume defined by a bottom and an upwardly extending sidewall, the pet bowl having a generally horizontal top surface;
a plurality of receiving openings formed in the horizontal top surface, each of the receiving opening comprising a wide opening and a narrow opening integrally connected; and
a lip portion partially extending into the interior volume with an access opening therethrough;
a plurality of downwardly extending portions that extend from the lip portion and removeably interlock with the receiving openings, each of the downwardly extending portions comprising a neck portion integral with the lip portion and a head portion integral with the neck portion, wherein the head portion is wider than the neck portion.
